(19) United States
(12) Patent Application Publication
(10) Pub. No.: US 2010/0304792 A1
(43) Pub. Date: Dec. 2, 2010

(54) ASSEMBLY OF PORTABLE ELECTRONIC DEVICE AND MOBILE COMMUNICATION DEVICE

(75) Inventors: Chia-Hsien LI, Taipei Hsien (TW); Wen-Chin Wu, Taipei Hsien (TW); Sung-Yu Hsieh, Taipei Hsien (TW); Pin-Yuan Yang, Taipei Hsien (TW); Pin-Hsien Su, Taipei Hsien (TW); Wen-Chieh Wu, Taipei Hsien (TW)

Correspondence Address: FOLEY AND LARDNER LLP;SUITE 500, 3000 K STREET NW, WASHINGTON, DC, 20007, US

(73) Assignee: WISTRON CORPORATION

(21) Appl. No.: 12/777,583

(22) Filed: May 11, 2010

(30) Foreign Application Priority Data
May 26, 2009 (TW) 098117428

(51) Int. Cl. H04B 1/38

(52) U.S. Cl. 455/566; 455/575.1

(57) ABSTRACT

A mobile communication device includes: an antenna module; a touchscreen for detecting a touching operation thereon; an application processor including an auxiliary display module that accesses information in a portable electronic device and sends the information to the touchscreen for display; a wireless communication unit controlled to retrieve data from the Internet for display on the touchscreen or the portable electronic device, or controlled to display a dialing interface on the touchscreen or the portable electronic device to allow for input of a telephone number; and a satellite navigation unit performing navigation based on information provided by a global positioning system and information in an electronic map database, and displaying navigation information on the touchscreen or the portable electronic device. The application processor activates the wireless communication unit, the satellite navigation unit, or the auxiliary display module according to a signal received from the touchscreen.

### CROSS-REFERENCE TO RELATED APPLICATION

This application claims priority of Taiwanese Application No. 098117428, filed on May 26, 2009.

### BACKGROUND OF THE INVENTION

1. Field of the Invention

The present invention relates to a mobile communication device, more particularly to a mobile communication device that can function as a medium for mobile digital transmission and as an auxiliary display for an electronic device.

2. Description of the Related Art

There is an ever-increasing demand for mobile networking, particularly in today's world of Web 2.0. However, since the use of mobile Internet devices (MIDs) is not widespread, most users fulfill their mobile Internet access requirements by using notebook computers or netbooks installed or used together with 3G (third generation) modules, mobile digital cards, or USB (universal serial bus) dongles. Therefore, regardless of whether built-in 3G modules, or external mobile digital cards or USB dongles are used, these devices provide notebook computers and netbooks with only digital transmission via the Internet, and do not provide other functionality.

Moreover, most present mobile communication devices, such as mobile phones, PDAs (personal digital assistants), smart phones, etc., provide mobile Internet access functionality, and some of these devices are equipped with a touchscreen and a GPS (global positioning system) navigation function.

Therefore, if suitable assembly were made between a mobile communication device and a portable electronic device, such as a notebook computer or a netbook, in addition to allowing the notebook computer or netbook to connect to the Internet through the mobile communication device, information in the notebook computer or netbook desired by the user could be retrieved through the mobile communication device for display on a screen of the mobile communication device, such that the user would be able to quickly gain access to information in the notebook computer or netbook, even when the notebook computer or netbook is turned off.

### SUMMARY OF THE INVENTION

Therefore, the object of the present invention is to provide an assembly of a portable electronic device and a mobile communication device, such that the mobile communication device functions as an auxiliary display and as a medium for digital transmission of the portable electronic device.

According to a first aspect of this invention, a mobile communication device is coupled electrically to a portable electronic device and includes: an antenna module; a touchscreen including a display, and a touch-control sensor stacked with the display for detecting a touching operation on the display and generating a corresponding touch-control signal; an application processor coupled electrically to the touchscreen and including an auxiliary display module, the auxiliary display module accessing predetermined information in the portable electronic device according to a setting and sending the information to the touchscreen for display thereon; a wireless communication unit coupled electrically to the antenna module and the application processor and including a mobile digital transceiver module, the wireless communication unit operating between a digital transmission mode and a mobile telephone mode, the mobile digital transceiver module being controlled when the wireless communication unit is in the digital transmission mode to be connected to the Internet through the antenna module to retrieve data for display on one of the touchscreen and the portable electronic device through the application processor, and the mobile digital transceiver module being controlled when the wireless communication unit is in the mobile telephone mode to generate a dialing interface for display on one of the touchscreen and the portable electronic device through the application processor to allow for input of a telephone number and connection to a telecommunications network using the telephone number; and a satellite navigation unit coupled electrically to the antenna module and the application processor and including an electronic map database, the satellite navigation unit performing navigation based on positioning information provided by a global positioning system and an electronic map in the electronic map database, and displaying navigation information on one of the touchscreen and the portable electronic device through the application processor. The application processor further includes a signal determining module which selects to activate one of the wireless communication unit, the satellite navigation unit, and the auxiliary display module according to a touch-control signal received from the touchscreen.

According to a second aspect of this invention, a mobile phone holder for receiving an electronic device comprises: a support arm; a fixing member connected pivotably to one end of the support arm for fixing the support arm to be suspended at a specific location; and an accommodation seat mounted to the other end of the support arm for receiving the electronic device, a speaker being disposed in a front plate of the accommodation seat, and an electric connector coupled electrically to the speaker being disposed in a bottom portion of the accommodation seat, the electronic device, when received in the accommodation seat, being coupled electrically to the electrical connector, such that sound signals generated by the electronic device may be output through the speaker.

According to a third aspect of this invention, an electronic system comprises a portable electronic device and a mobile communication device.

The portable electronic device includes a host, a display, and a main housing having a host housing section and a lid section. The host housing section encapsulates the host. The lid section receives the display. A receiving seat is disposed on an upper surface of one of the host housing section and the lid section. A first connection interface electrically coupled to the host is disposed in the receiving seat.

The mobile communication device includes: a device housing received removably in the receiving seat; a second connection interface disposed on a side of the device housing for coupling electrically to the first connection interface; an antenna module; a touchscreen including a display, and a touch-control sensor stacked with the display for detecting a touching operation on the display and generating a corresponding touch-control signal; an application processor coupled electrically to the touchscreen and the second connection interface, and including an auxiliary display module, the auxiliary display module accessing predetermined information in the portable electronic device and sending the information to the touchscreen for display thereon; a wireless communication unit coupled electrically to the antenna module and the application processor and including a mobile digital transceiver module, the wireless communication unit operating between a digital transmission mode and a mobile telephone mode, the mobile digital transceiver module being controlled when the wireless communication unit is in the digital transmission mode to be connected to the Internet through the antenna module to retrieve data for display on the portable electronic device through the application processor, and the mobile digital transceiver module being controlled when the wireless communication unit is in the mobile telephone mode to generate a dialing interface for display on the portable electronic device through the application processor to allow for input of a telephone number and connection to a telecommunications network using the telephone number; and a satellite navigation unit coupled electrically to the antenna module and the application processor, and installed with a global satellite positioning system and an electronic map database, the satellite navigation unit performing navigation based on positioning information provided by the global positioning system and an electronic map in the electronic map database, and displaying navigation information on the display of the portable electronic device through the application processor.

The application processor further includes a signal determining module which selects to activate one of the wireless communication unit, the satellite navigation unit, and the auxiliary display module according to a touch-control signal received from the touchscreen.

### BRIEF DESCRIPTION OF THE DRAWINGS

Other features and advantages of the present invent ion will become apparent in the following detailed description of the preferred embodiments with reference to the accompanying drawings, of which:

FIG. 1 is a perspective view of the first preferred embodiment of an assembly of a portable electronic device and a mobile communication device according to the present invention, illustrating a receiving seat of the portable electronic device being disposed on an upper surface of a host housing section of the portable electronic device;

FIG. 2 is an exploded perspective view of the mobile communication device of the first preferred embodiment;

FIG. 3 is a perspective view, illustrating the mobile communication device of the first preferred embodiment in a state received in the receiving seat;

FIG. 4 is a schematic circuit block diagram of a circuit board 300 of the mobile communication device of the first preferred embodiment;

FIG. 5 is a schematic diagram of a menu provided by the mobile communication device of the first preferred embodiment;

FIGS. 6˜9 are schematic diagrams, illustrating the steps involved in setting up an Internet connection according to the first preferred embodiment;

FIG. 10 is a schematic diagram, illustrating a dialing interface according to the first preferred embodiment;

FIG. 11 is a schematic diagram, illustrating a window showing an incoming telephone call according to the first preferred embodiment;

FIG. 12 is a schematic diagram, illustrating a satellite navigation screen according to the first preferred embodiment;

FIG. 13 is a schematic diagram, illustrating a screen for establishing SideShow tools according the first preferred embodiment;

FIG. 14 is a schematic diagram, illustrating SideShow tool icons appearing on a touchscreen of the first preferred embodiment;

FIG. 15 is a partially exploded perspective view of a mobile phone holder and the mobile communication device according to the first preferred embodiment;

FIG. 16 is a perspective view, illustrating the mobile communication device in a state received in the mobile phone holder;

FIG. 17 is a perspective view of the second preferred embodiment of an assembly of a portable electronic device and a mobile communication device according to the present invention, illustrating a receiving seat for the portable electronic device being disposed on an outer surface of a lid section of the portable electronic device; and

FIG. 18 is a perspective view, illustrating the mobile communication device of the second preferred embodiment in a state received in the receiving seat.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

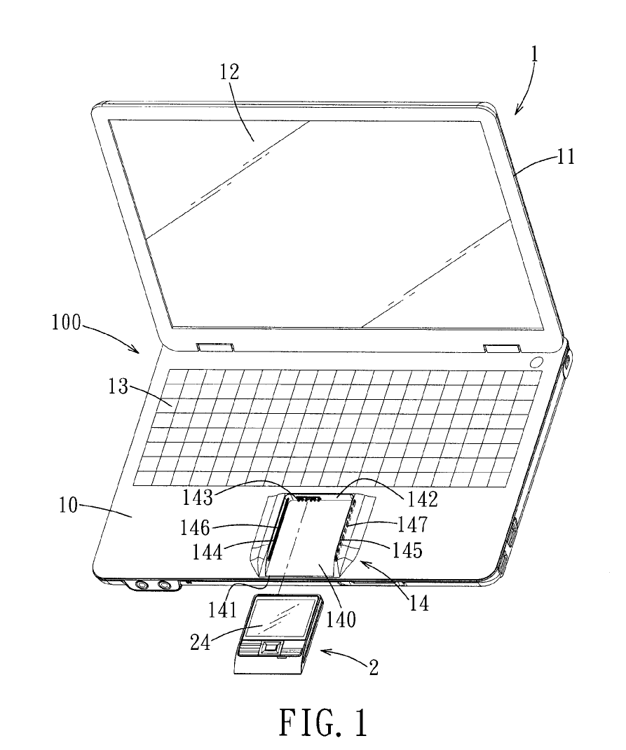

Referring to FIG. 1, the first preferred embodiment of an assembly of a portable electronic device and a mobile communication device of this invention (hereinafter also referred to as an electronic system) comprises a portable electronic device 1 and a mobile communication device 2. In this embodiment, the portable electronic device 1 is a notebook computer. However, the portable electronic device 1 is not limited in this regard and may also be a mobile Internet device (MID), a netbook, an ultra mobile personal computer (UMPC), a digital camera, etc. In this embodiment, the mobile communication device 2 is an electronic device that combines the functions of a mobile phone, a MID, a personal navigation device (PND), and SideShow.

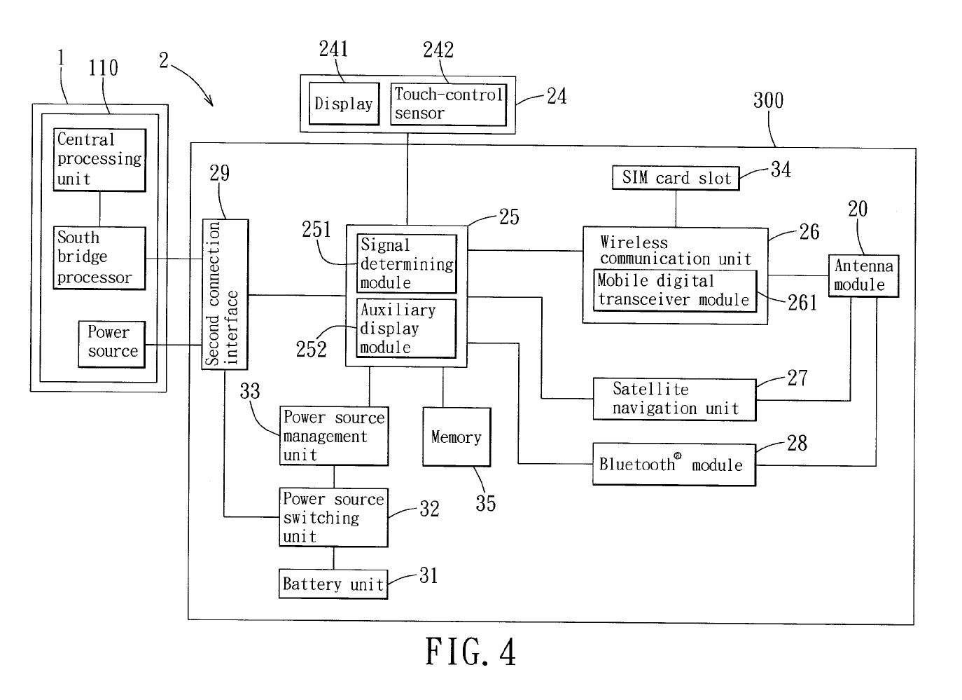

The notebook computer 1 includes a host 110 (see FIG. 4) and a main housing 100. The main housing 100 includes a host housing section 10 and a lid section 11 pivotable with respect to the host housing section 10. A flat display 12, which is electrically coupled to the host 110, is disposed in the lid section 11 facing the host housing section 10. The host housing section 10 encapsulates the host 110, includes a keyboard 13 that is disposed on a side thereof that faces the lid section 11, and is formed with a receiving seat 14 disposed below the keyboard 13 and that opens downwardly. The receiving seat 14 confines a generally rectangular groove that has a first side 141 opening outwardly, and a second side 142 opposite to the first side 141 and on which is disposed a first connection interface 143 coupled electrically to the host 110 (an alternative is for the first connection interface 143 to be disposed on a bottom face 140 of the receiving seat 14). The receiving seat 14 further has a third side 144 and a fourth side 145 opposite to each other and perpendicular to the second side 142, and along which are disposed parallel slide rails 146, 147, respectively.

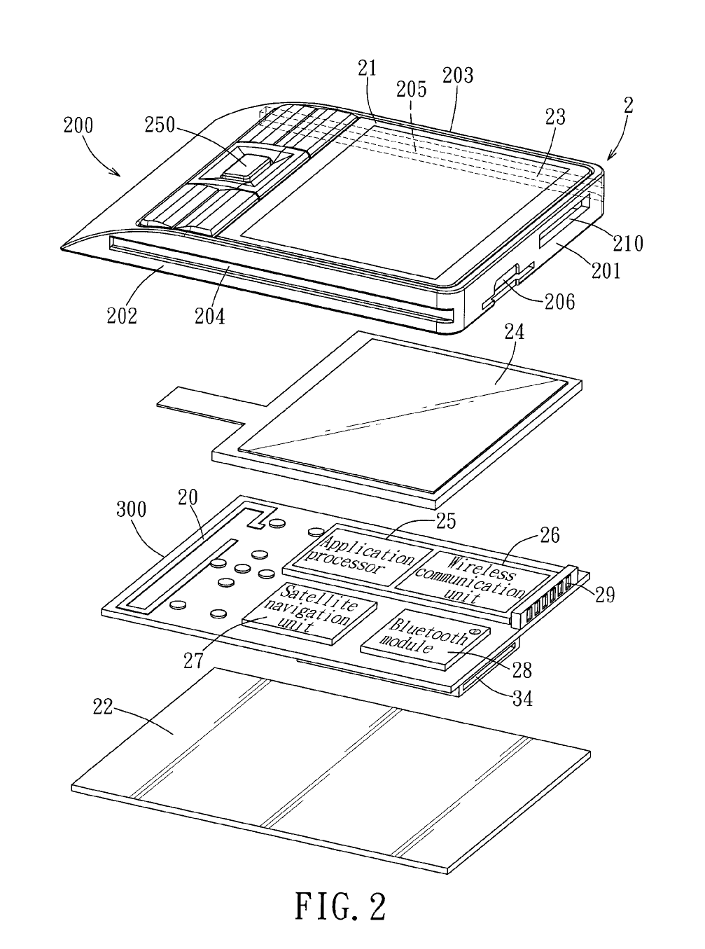

As shown in FIG. 2, the mobile communication device 2 includes a device housing 200 and a circuit board 300. The device housing 200 includes an upper housing body 21 and a lower housing body 22. The upper housing body 21 is formed with a cutout region 23 for mounting of a touchscreen 24 therein, and includes a button 250 disposed below the cutout region 23 for operating the mobile communication device 2. The circuit board 300 is encapsulated in the device housing 200 and coupled electrically to the touchscreen 24. The circuit board 300 includes an antenna module 20, an application processor 25, a wireless communication unit 26, a satellite navigation unit 27, a Bluetooth® module 28, and a second connection interface 29 mounted at an edge of the circuit board 300. The device housing 200 has a side 201 formed with an opening 210 registered with the second connection interface 29 such that the second connection interface 29 is exposed. In this embodiment, the first connection interface 143 and the second connection interface 29 are connectable USB connectors. The functions of the circuit board 300 are described hereinafter.

The size of the device housing 200 and the spatial dimensions of the receiving seat 14 roughly correspond to each other, and the upper housing body 21 of the device housing 200 has a pair of opposite lateral sides 202, 203 that are transverse to the side 201 in which the second connection interface 29 is disposed. The lateral sides 202, 203 are formed respectively with parallel guide grooves 204, 205 extending therealong.

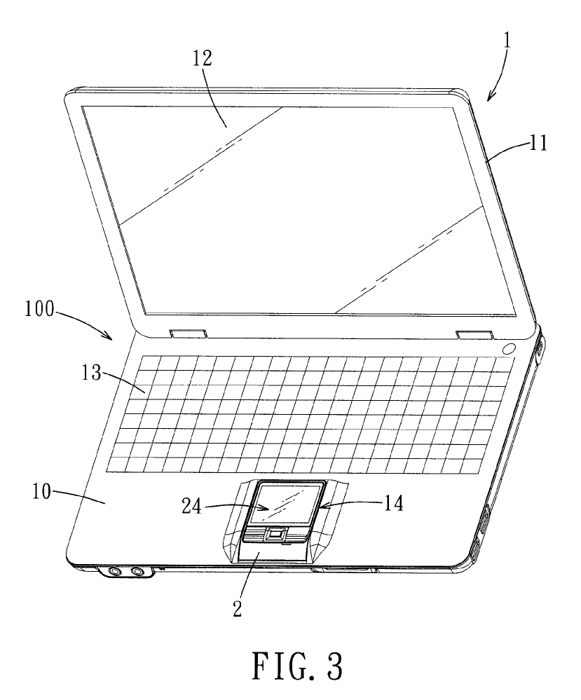

As shown in FIG. 3, when the mobile communication device 2 is pushed into the receiving seat 14 of the notebook computer 1, through cooperation between the guide grooves 204, 205 and the guide rails 146, 147 in the receiving seat 14 of the notebook computer 1, the mobile communication device 2 slid into the receiving seat 14, and the first connection interface 143 is coupled to the second connection interface 29 to realize electrical connection therebetween.

Therefore, after the mobile communication device 2 is received in the receiving seat 14 of the notebook computer 1 and realizes electrical connection with the notebook computer 1, the circuit board 300 of the mobile communication device 2 can communicate with the host 110 of the notebook computer 1 through the second connection interface 29 and the first connection interface 143.

FIG. 4 is a schematic circuit block diagram of the circuit board 300 of the mobile communication device 2. The antenna module 20 includes an antenna for use by the wireless communication unit 26, an antenna for use by the satellite navigation unit 27, and an antenna for use by the Bluetooth® module 28.

The touchscreen 24 is coupled electrically to the application processor 25, and includes a flat display 241 and a touch-control sensor 242 stacked with the display 241 for detecting touching operations on the display 241 and generating corresponding touch-control signals for transmission to the application processor 25.

The application processor 25 includes a signal determining module 251 and an auxiliary display module 252. The signal determining module 251 outputs a control command corresponding to the touch-control signal received from the touchscreen 24. According to the set up by a user, the auxiliary display module 252 stores information that is in the notebook computer 1, and sends the information to the touchscreen 24 for display thereon. It is to be noted that the application processor 25 may be an x86 chip commonly used in notebook computers, such as processor chips manufactured by Intel®, AMD®, VIA®, etc., but the present invention is not limited in this regard. The operating system used by the application processor 25 may be Windows® XP, Windows® VISTA, Windows® 7, Windows® CE, Linux®, etc., and the present invention is not limited in this respect.

The wireless communication unit 26 includes a mobile digital transceiver module 261, and is coupled electrically to the antenna module 20 and the application processor 25. The wireless communication unit 26 operates between a digital transmission mode and a mobile telephone mode. In the digital transmission mode, the mobile digital transceiver module 261 is controlled to be connected to the Internet through the antenna module 20. In the mobile telephone mode, the mobile digital transceiver module 261 generates a dialing interface for display on the touchscreen 24 via the application processor 25, such that the user is able to input a telephone number through the dialing interface. Also, in the mobile telephone mode, the mobile digital transceiver module 261 is connected to a telecommunications network via the antenna module 20, so as to realize telephone connection and communication. The mobile digital transceiver module 261 may employ 3G (third generation) or 3.5G wireless networking standards, or future 4G wireless networking standards.

The satellite navigation unit 27 is coupled electrically to the antenna module 20 and the application processor 25, and is installed with a global satellite positioning system (not shown) and an electronic map database (stored in a memory 35 which is coupled electrically to the application processor 25). Similar to the functions of existing satellite navigation devices, the satellite navigation unit 27 performs navigation based on positioning information provided by the global positioning system and an electronic map stored in the electronic map database, and displays navigation information on the touchscreen 24 through the application processor 25.

When the mobile communication device 2 is pushed into the receiving seat 14 of the notebook computer 1 to realize electrical connection with the host 110 in a state where the mobile communication device 2 is turned on, both the application processor 25 and the host 110 of the notebook computer 1 detect this event. In response, the notebook computer 1 utilizes the touchscreen 24 of the mobile communication device 2 as an input interface so as to function in the manner of a touch pad in a conventional notebook computer. That is, any touch control operation on the touchscreen 24, such as an operation controlling movement of a cursor, a click, etc., is detected by the touch-control sensor 242 of the touchscreen 24 and converted into a touch-control signal for subsequent output to the application processor 25. The application processor 25 then sends the touch-control signal to the host 110 of the notebook computer 1 through the second connection interface 29 for the host 110 to perform corresponding control. Therefore, a user can control the functions and operations of the notebook computer 1 through operation of the touchscreen 24.

Moreover, the mobile communication device 2 further includes a battery unit 31 for supplying electric power to the electronic components of the mobile communication device 2, a power source switching unit 32 coupled electrically to the battery unit 31 and the second connection interface 29, and a power source management unit 33 coupled electrically to the power source switching unit 32 and the application processor 25 and controlled by the application processor 25. When the application processor 25 detects that the mobile communication device 2 is coupled electrically to the notebook computer 1, the application processor 25 controls the power source management unit 33 to select use of power from the notebook computer 1. Therefore, the power source management unit 33 sends a switching signal to the power source switching unit 32 for the same to select power from the notebook computer 1 transmitted through the second connection interface 29 for supply to the electronic components of the mobile communication device 2 and to the battery unit 31 to charge the same. In such a manner, the power of the mobile communication device 2 is saved, such that the power of the battery unit 31 thereof lasts longer when the mobile communication device 2 is used by itself.

The notebook computer 1 treats the mobile communication device 2 as a peripheral device thereof, and shows an icon indicating the mobile communication device 2 at the right bottom corner of the screen of the display 12.

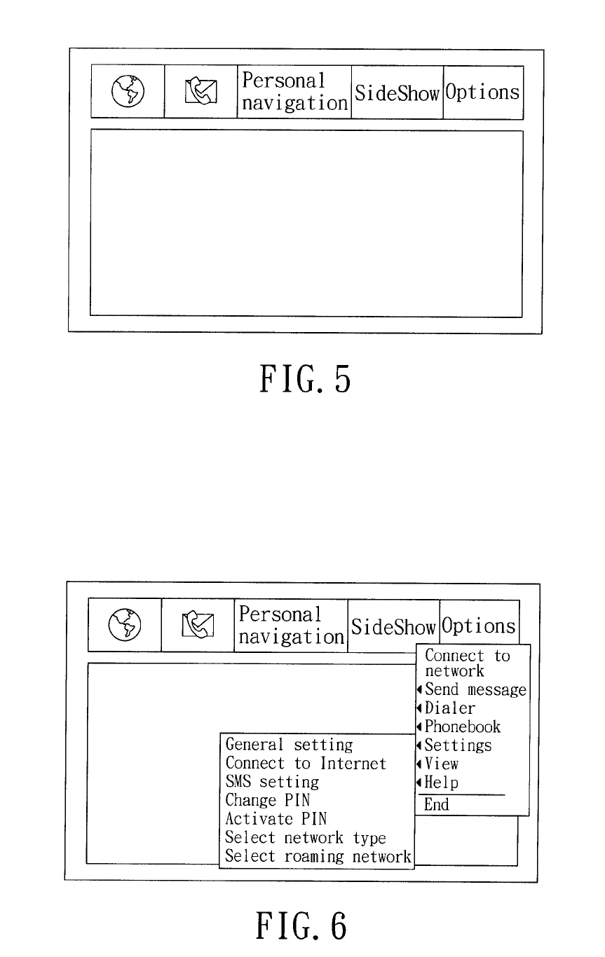

When it is desired to use the functions of the mobile communication device 2, this icon may be clicked for activation of the mobile communication device 2. In response, the application processor 25 generates a menu as shown in FIG. 5, and sends the menu to the notebook computer 1 for display on the display 12.

The menu includes the menu items of “wireless network connection” (which may be shown by way of an icon as shown in FIG. 5), “place call” (which may be shown by way of icon as shown in FIG. 5), “personal navigation,” and “SideShow.” The user can select the desired function by activating the menu item through the touchscreen 24.

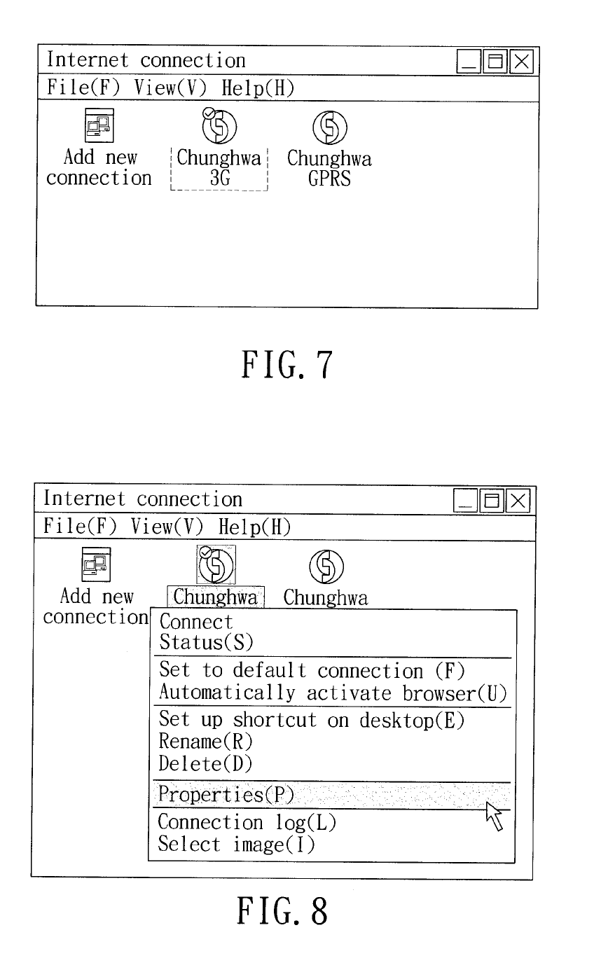

As in the case of a typical present 3G mobile digital card, such as the Asus® T500 card, before using the wireless network connection function, some basic set up must be performed with respect to the wireless communication unit 26. As shown in FIG. 6, the manner in which connection to the Internet is performed is first established. For example, as shown in FIGS. 7 and 8, a telecommunications provider such as “Chunghwa 3G,” “Chunghwa GPRS,” etc. may be selected and the properties thereof may be set up. Next, as shown in FIG. 9, subscriber basic data is filled in, thereby completing the basic configuration operation.

Whenever the user subsequently selects “wireless network connection,” a corresponding command is sent to the application processor 25, and the application processor 25 activates the wireless communication unit 26 to control the mobile digital transceiver module 261 thereof to connect the notebook computer 1 to the Internet through the telecommunications network according to the digital transmission mode configured as described above.

The mobile communication device 2 further includes a SIM (subscriber identity module) card slot 34 coupled electrically to the wireless communication unit 26, and the side 201 of the upper housing body 21 of the wireless communication unit 26 is formed with a slot hole 206 registered with the SIM card slot 34 such that a SIM card (not shown) may be inserted into the SIM card slot 34 through the slot hole 206 for electrical connection with the wireless communication unit 26, thereby allowing the wireless communication unit 26 to access the subscriber information on the SIM card.

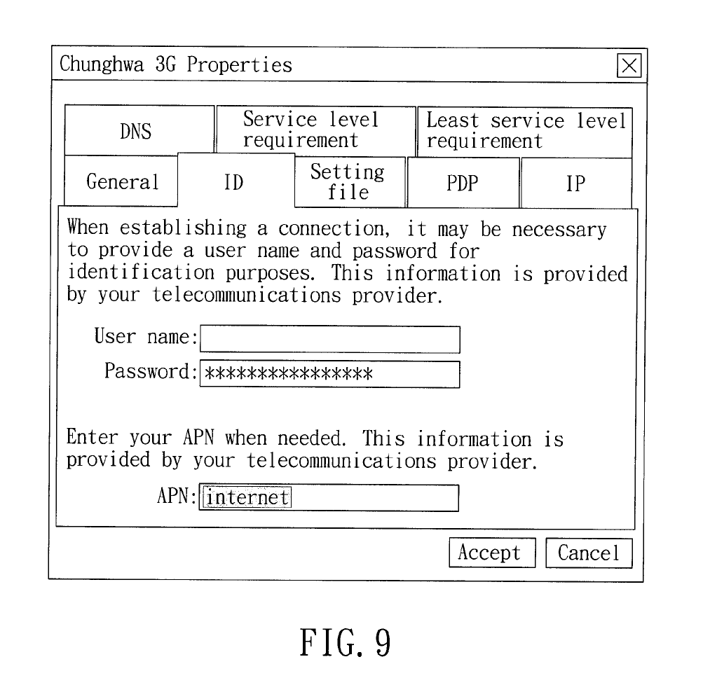

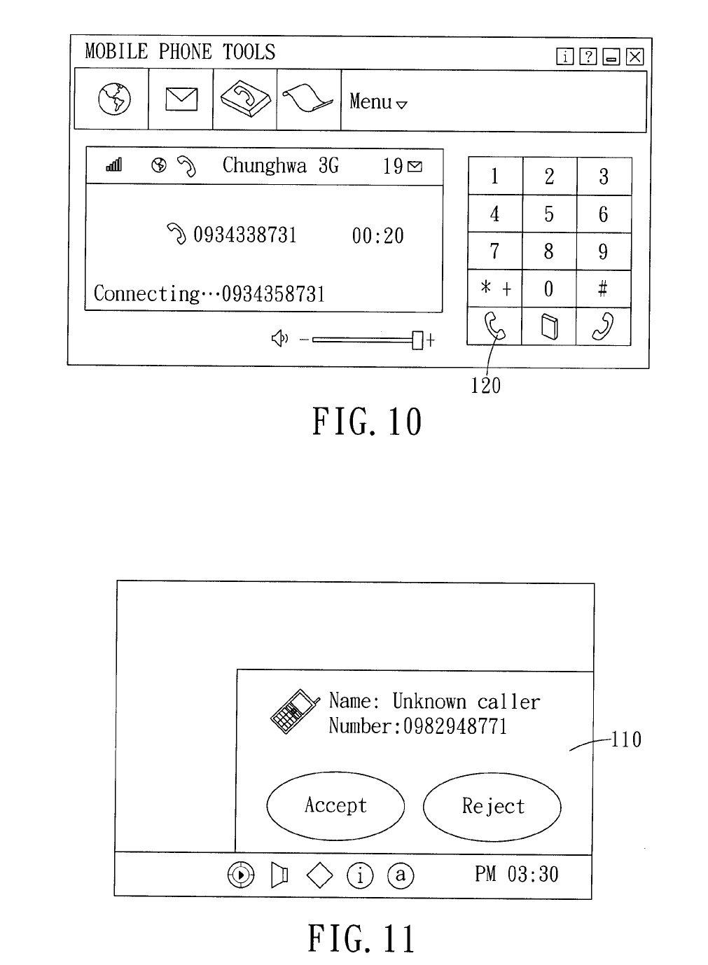

Therefore, when the user selects the menu item of “place call,” the command is sent to the application processor 25 to activate the wireless communication unit 26, and the mobile digital transceiver module 261 executes the mobile telephone mode according to the aforementioned user's configuration, reads the subscriber information and data, such as phone book data, text messages, etc., and generates an interface for placing a call as shown in FIG. 10 on the display 12 of the notebook computer 1. A numeric pad and a display window are displayed in the interface for placing a call so that the user can input a telephone number using a mouse or the touchscreen 24, or can select a telephone number from the phone book, after which in either case the user completes placing of the call by pressing a call key 120 of the numeric pad.

At the same time, when the user uses the mobile digital transceiver module 261 to place a call, the application processor 25 automatically activates the Bluetooth® module 28 so that the Bluetooth® module 28 performs a matching and communication protocol with respect to a Bluetooth® headset (not shown) worn by the user, such that the user can wirelessly conduct a call through the Bluetooth® headset and the Bluetooth® module 28 (i.e., conversation signals are transmitted therebetween).

When there is an incoming call, with reference to FIG. 11, the application processor 25 generates an incoming call window 110 at the right bottom corner of the screen of the display 12 of the notebook computer 1, notifies the user of the telephone number of the incoming call, and controls the notebook computer 1 to output a ring tone. The user may press a call receive key (i.e., the call key 120) on the numeric pad to answer the incoming call. At this time, the Bluetooth® module 28 is activated by the application processor 25 so that the user can wirelessly conduct a call through the Bluetooth® headset and the Bluetooth® module 28.

The function of placing a telephone call through the mobile digital transceiver module 261 by the wireless communication unit 26 of this embodiment can be realized by using a presently available 3G digital mobile card, such as the Asus® T500 card.

Of course, in a manner similar to that used in a typical mobile phone, a headset terminal (not shown) that is coupled electrically to the application processor 25 and into which a wired headset (not shown) is plugged may be provided in the mobile communication device 2, such that the user can conduct a call using the wired headset. Therefore, when the application processor 25 detects that a wired headset is plugged into the headset terminal, the application processor 25 automatically disables the Bluetooth® module 28.

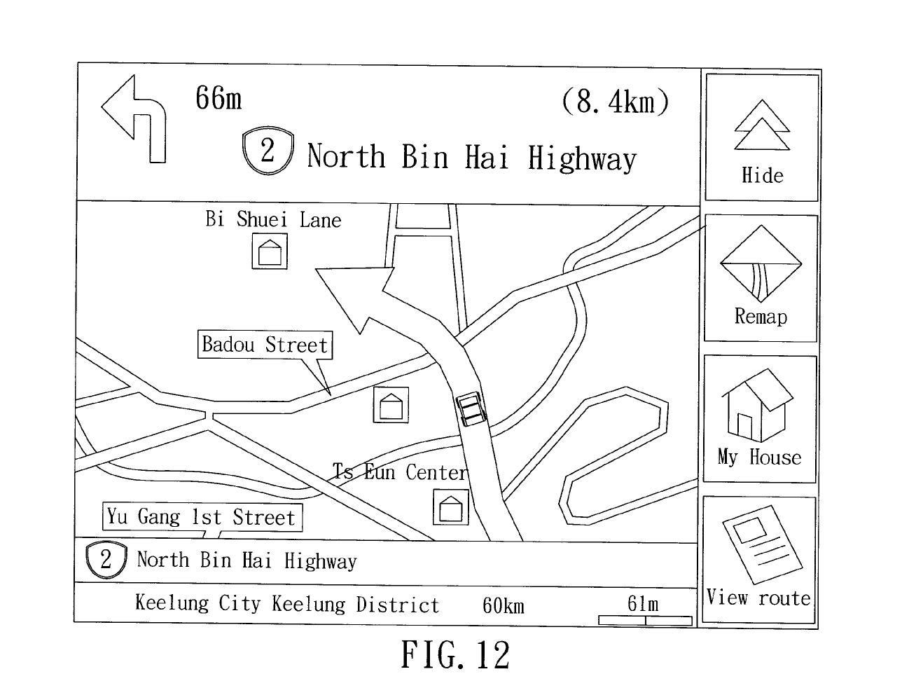

When the user selects the menu item “personal navigation,” the application processor 25 receives the corresponding command, and activates the satellite navigation unit 27 to use the electronic map database in the memory 35 and positioning information supplied by a global positioning system for positioning and navigation with respect to the present position of the user. With reference to FIG. 12, the satellite navigation unit 27 sends navigation information to be displayed on the display 12 of the notebook computer 1 through the application processor 25. Moreover, in a manner similar to present satellite navigation devices, the user can set up the starting and ending points of navigation through the touchscreen 24 or the keyboard 13 of the notebook computer 1, such that the satellite navigation unit 27 generates a navigation route and displays the same on the display 12 of the notebook computer 1.

Furthermore, when the notebook computer 1 is shut down and it is desired to retrieve some information, such as a calendar, contacts, emails, etc., from the notebook computer 1 without turning on the notebook computer 1, information in the notebook computer 1 may be retrieved through the auxiliary display module 252 of the application processor 25. The auxiliary display module 252 may also be referred to as SideShow, which is an auxiliary display technology provided by Microsoft Windows® Vista in which an auxiliary display of a portable electronic device, such as the notebook computer 1, can be used to display important information the user needs, regardless of whether the notebook computer 1 is currently in use, shut down, or in a “sleep” mode.

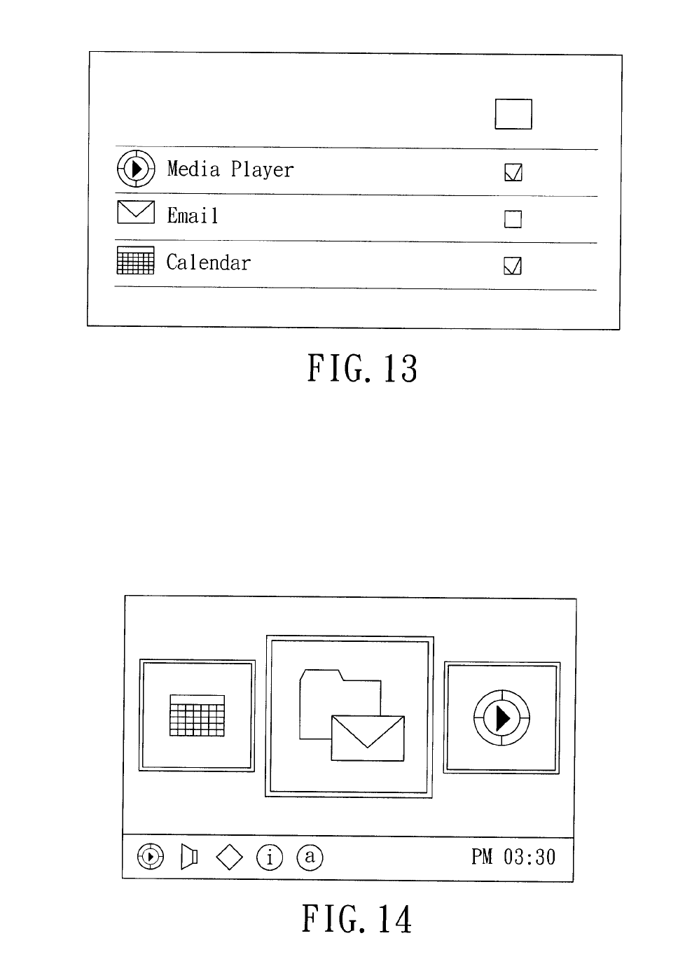

When the auxiliary display module 252 is used for the first time by the application processor 25, with reference to FIG. 13, the user has to configure which of the tools are to be used to retrieve the information of the notebook computer 1 through a tool configuration window generated by the auxiliary display module 252. If the notebook computer 1 is installed with Microsoft Windows® Vista Operating System, Windows® Vista Operating System will preset two tools, that is, Windows® Mail and Windows® Media Player, and the user is able to configure other tools, such as the calendar in Office Outlook 2007 calendar, an album, etc. When the auxiliary display module 252 is activated after the user completes configuration, with reference to FIG. 14, the screen of the touchscreen 24 will show the icons of the tools, and, in a state where the notebook computer 1 is not turned off, the auxiliary display module 252 periodically sends information desired by the user in the notebook computer 1, such as the newest mail in the mail inbox and calendar information, to the memory 35 which is coupled to the application processor 25.

When the lid section 11 of the notebook computer 1 is closed, data that the user desires is already stored in the memory 35 of the application processor 25, such that, with reference to FIG. 14, the user can read the contents of email, a calendar, and an album through the icons of the mail inbox, calendar, and album without activating the notebook computer 1.

Moreover, the application processor 25 of the mobile communication device 2 can switch the touchscreen 24 between a touch pad mode and a touch panel mode depending on the situation or according to selection by the user. For instance, when the display 12 of the notebook computer 1 displays the menu as shown in FIG. 5, in order to permit the user to select a menu item of the menu through the touchscreen 24, the application processor 25 switches the touchscreen 24 to the touch pad mode. When the user intends to select a function item appearing directly in the touchscreen 24, such as handwriting, start, turn off, etc., the application processor 25 switches the touchscreen 24 to the touch panel mode so that the user can select the function items shown by the touchscreen 24.

Of course, the application processor 25 may also generate a virtual keyboard on the touchscreen 24 to allow the user to input data through the virtual keyboard in the touch panel mode. Also, the virtual keyboard may be used in place of the physical keyboard of the conventional notebook computer.

When the mobile communication device 2 is removed from the receiving seat 14 of the notebook computer 1, the application processor 25 detects this event, and controls the power source management unit 33 to transmit a switching signal to the power source switching unit 32 to cause the same to select power from the battery unit 31 of the mobile communication device 2 itself. At the same time, the application processor 25 performs control such that the menu is displayed in the touchscreen 24 and controls the touchscreen 24 to operate in the touch panel mode. Since the mobile communication device 2 is already removed from the notebook computer 1, the Sideshow function is suspended, and hence, the menu item of “SideShow” is no longer shown in the menu.

When the mobile communication device 2 is used by itself, the user can still select the functions of wireless network connection, place a call, and “personal navigation,” and the relevant window screens are shown on the touchscreen 24 for operation as described above.

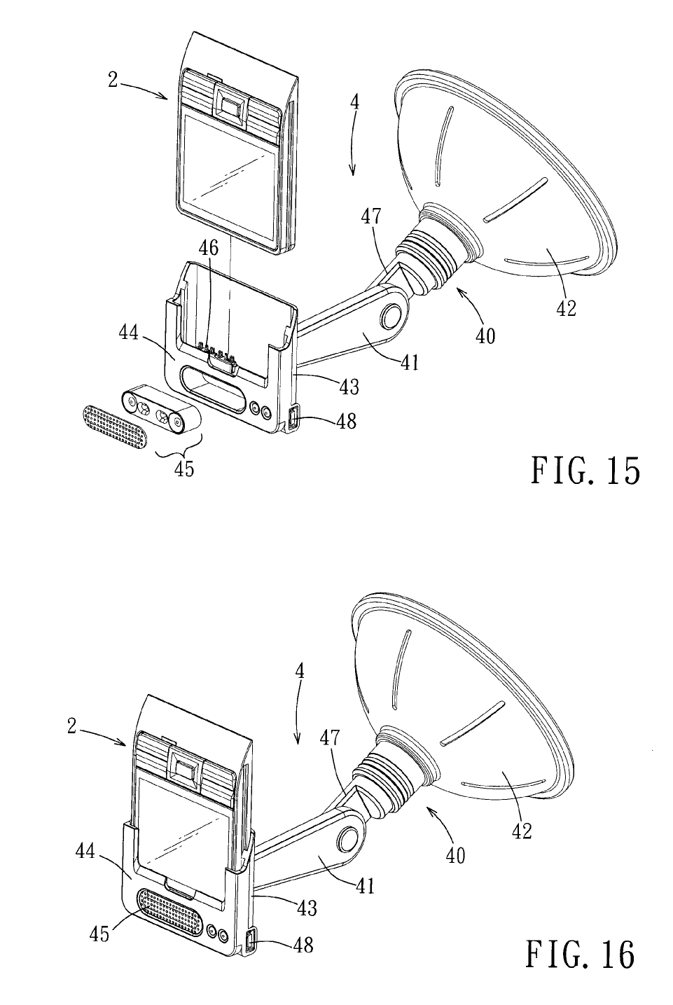

Referring to FIGS. 15 and 16, the mobile communication device 2 can also be received in a mobile phone holder 4. The mobile phone holder 4 includes a support arm 41, a fixing member 40 connected pivotably to one end of the support arm 41, and an accommodation seat 43 mounted to the other end of the support arm 41. The fixing member 40 includes a pivot arm 47 and a suction cup 42. One end of the pivot arm 47 is fixed to the suction cup 42, and the other end of the pivot arm 47 is tightly and pivotally connected to the support arm 41. The suction cup 42 may be attached by suction on a windshield of a vehicle (not shown) such that the support arm 41 is suspended at a specific location, and the support arm 41 can be pivoted relative to the pivot arm 47 by application of a force thereon to change the suspension position of the support arm 41.

In addition, a speaker 45 is disposed in a front plate 44 of the accommodation seat 43, and a third electric connector 46 coupled electrically to the speaker 45 is disposed in a bottom portion of the accommodation seat 43. A power source connector 48 coupled electrically to the third electric connector 46 and the speaker 45 is disposed in the accommodation seat 43 for connection electrically with an external power source, such as a car power source, for receiving power therefrom. When the mobile communication device 2 is inserted into the accommodation seat 43, the second connection interface 29 (see FIG. 4) of the mobile communication device 2 realizes electrical connection with the third electric connector 46, and power is provided to the speaker 45 and the mobile communication device 2 from the power source connector 48, such that the sound signals generated by the mobile communication device 2 may be output through the speaker 45.

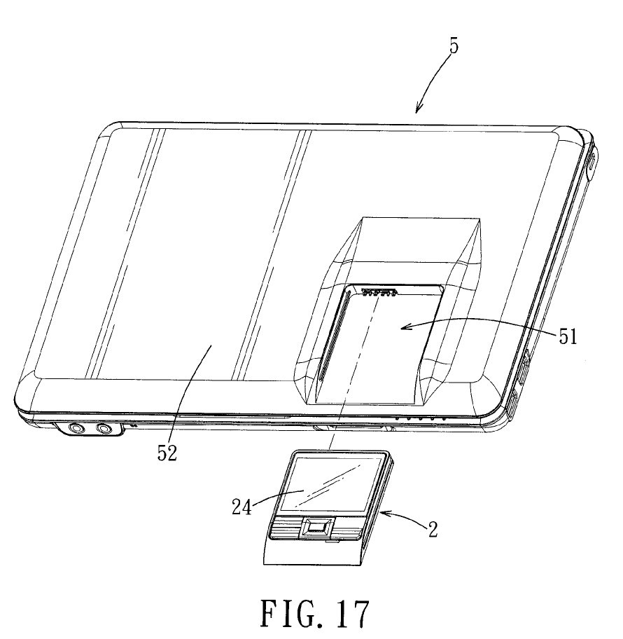

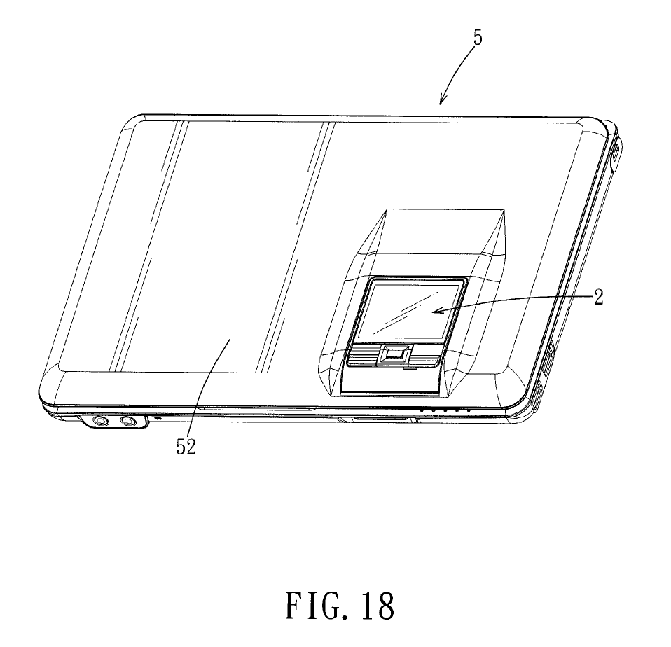

FIGS. 17 and 18 show the second preferred embodiment of an assembly of a portable electronic device and a mobile communication device according to this invention. As in the previous embodiment, an example is given in which the portable electronic device is a notebook computer 5 in this embodiment. The differences with the first preferred embodiment are as described below.

The receiving seat 51 for receiving the mobile communication device 2 is disposed on an outer surface of a lid section 52 of the notebook computer 5. Hence, when the mobile communication device 2 is received in the receiving seat 51 and electrically coupled to the notebook computer 5, the mobile communication device 2 shows a menu including menu items of “wireless network connection,” “place a call,” “personal navigation,” and “SideShow” on the touchscreen 24, and the touchscreen 24 operates in the touch panel mode. The user can select and activate a desired function using the touchscreen 24.

Therefore, when the lid section 52 of the notebook computer 5 is closed, regardless of whether the notebook computer 5 is shut down or in a standby mode, in the same manner as described above, the user can still check information (including the calendar, contacts, pictures, new email, etc.) in the notebook computer 5 using the “SideShow” function of the mobile communication device 2 in a state where the lid section 52 of the notebook computer 5 is closed.

It is to be noted that, in addition to provision of the functions of wireless network communication, a mobile phone, personal satellite navigation, and SideShow, the mobile communication device 2 can also serve as a security key for the notebook computer 1, 5. That is, with such a configuration, before the notebook computer 1, 5 is turned on, the mobile communication device 2 has to be received in the receiving seat 14, 51 of the notebook computer 1, 5. For example, when the notebook computer 1, 5 checks peripheral devices after being turned on, the notebook computer 1, 5 detects whether the mobile communication device 2 is present (i.e., connected), and in the negative, the system boot-up operation is aborted. Furthermore, each of the memories of the mobile communication device 2 and the notebook computer 1, 5 can be configured to pre-store an identification code, and when the notebook computer 1, 5 detects the presence of the mobile communication device 2, the notebook computer 1, 5 further checks whether the identification codes are identical, and in the negative, the system boot-up operation is aborted. Therefore, the mobile communication device 2 can be further used to provide data security for the notebook computer 1, 5.

Of course, a conventional WiFi communication system (not shown) may be installed in the notebook computer 1, 5 so that flexibility is provided to the user with respect to selecting whether to connect to the Internet through the wireless communication unit 26 of the mobile communication device 2 or the WiFi communication system of the notebook computer 1, 5.

From the aforementioned, the foregoing mobile communication device 2 of this invention integrates mobile digital transmission, personal satellite navigation, and the SideShow auxiliary display functions into a single unit. Therefore, in addition to operating as a medium for wireless Internet access for a portable electronic device, the mobile communication device 2 further provides personal satellite navigation, and an auxiliary display function for the portable electronic device, such that the purpose of this invention is achieved.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A mobile communication device capable of being coupled electrically to a portable electronic device, comprising:
an antenna module;
a touchscreen including a display, and a touch-control sensor stacked with said display for detecting a touching operation on said display and generating a corresponding touch-control signal;
an application processor coupled electrically to said touchscreen and including an auxiliary display module, said auxiliary display module accessing predetermined information in the portable electronic device according to a setting and s ending the information to said touchscreen for display thereon;
a wireless communication unit coupled electrically to said antenna module and said application processor and including a mobile digital transceiver module, said wireless communication unit operating between a digital transmission mode and a mobile telephone mode, said mobile digital transceiver module being controlled when said wireless communication unit is in the digital transmission mode to be connected to the Internet through said antenna module to retrieve data for display on one of said touchscreen and the portable electronic device through said application processor, and said mobile digital transceiver module being controlled when said wireless communication unit is in the mobile telephone mode to generate a dialing interface for display on one of said touchscreen and the portable electronic device through said application processor to allow for input of a telephone number and connection to a telecommunications network using the telephone number; and
a satellite navigation unit coupled electrically to said antenna module and said application processor and including an electronic map database, said satellite navigation unit performing navigation based on positioning information provided by a global positioning system and an electronic map in said electronic map database, and displaying navigation information on one of said touchscreen and the portable electronic device through said application processor;
said application processor further including a signal determining module which selects to activate one of said wireless communication unit, said satellite navigation unit, and said auxiliary display module according to a touch-control signal received from said touchscreen.

2. The mobile communication device of claim 1, wherein when said mobile communication device is coupled electrically to the portable electronic device, information obtained by said mobile communication device is transmitted to the portable electronic device for display through said application processor, and when said mobile communication device is not coupled electrically to the portable electronic device, information obtained by said mobile communication device is transmitted to said touchscreen for display through said application processor.

3. The mobile communication device of claim 1, wherein when said mobile communication device is coupled electrically to the portable electronic device, the dialing interface generated by said mobile digital transceiver module is transmitted to the portable electronic device for display through said application processor, and when said mobile communication device is not coupled electrically to the portable electronic device, the dialing interface generated by said mobile digital transceiver module is transmitted to said touchscreen for display through said application processor.

4. The mobile communication device of claim 1, wherein when said mobile communication device is coupled electrically to the portable electronic device, the navigation information is transmitted to the portable electronic device for display through said application processor, and when said mobile communication device is not coupled electrically to the portable electronic device, the navigation information is transmitted to said touchscreen for display through said application processor.

5. The mobile communication device of claim 1, further comprising a connection interface coupled electrically to said application processor, said application processor being coupled electrically to the portable electronic device through said connection interface.

6. The mobile communication device of claim 5, further comprising a battery unit for supplying electric power, a power source switching unit coupled electrically to said battery unit and said connection interface, and a power source management unit coupled electrically to said power source switching unit and said application processor and controlled by said application processor;
said application processor controlling said power source switching unit through said power source management unit to select use of power from the portable electronic device when said application processor is coupled electrically to the portable electronic device;
said application processor controlling said power source switching unit through said power source management unit to select use of power from said battery unit when said application processor is not coupled electrically to the portable electronic device.

7. The mobile communication device of claim 1, further comprising a Bluetooth® module coupled electrically to said application processor, said application processor automatically activating said Bluetooth® module to transmit and receive conversation signals when said wireless communication unit is operating in the mobile telephone mode.

8. The mobile communication device of claim 1, further comprising a memory coupled electrically to said application processor, the information accessed from the portable electronic device by said auxiliary display module and said electronic map database being stored in said memory.

9. A mobile phone holder for receiving an electronic device, said mobile phone holder comprising:
a support arm;
a fixing member connected pivotably to one end of said support arm for fixing said support arm to be suspended at a specific location; and
an accommodation seat mounted to the other end of said support arm for receiving the electronic device, a speaker being disposed in a front plate of said accommodation seat, and an electric connector coupled electrically to said speaker being disposed in a bottom portion of said accommodation seat, the electronic device, when received in said accommodation seat, being coupled electrically to said electrical connector, such that sound signals generated by the electronic device may be output through said speaker.

10. The mobile phone holder of claim 9, wherein said fixing member includes a pivot arm and a suction cup, one end of said pivot arm being fixed to said suction cup, and the other end of said pivot arm being tightly and pivotally connected to one end of said support arm, such that said support arm can be pivoted relative to said pivot arm by application of a force thereon to change the suspension position of said support arm.

11. The mobile phone holder of claim 9, wherein a power source connector coupled electrically to said electrical connector and said speaker is disposed in said accommodation seat for connection electrically with an external power source to provide power to said speaker and the electronic device.

12. An electronic system comprising:
a portable electronic device including
a host,
a display, and
a main housing having a host housing section and a lid section, said host housing section encapsulating said host, said lid section receiving said display, a receiving seat being disposed on an upper surface of one of said host housing section and said lid section, a first connection interface electrically coupled to said host being disposed in said receiving seat;
a mobile communication device including
a device housing received removably in said receiving seat,
a second connection interface disposed on a side of said device housing for coupling electrically to said first connection interface,
an antenna module,
a touchscreen including a display, and a touch-control sensor stacked with said display for detecting a touching operation on said display and generating a corresponding touch-control signal,
an application processor coupled electrically to said touchscreen and said second connection interface, and including an auxiliary display module, said auxiliary display module accessing predetermined information in said portable electronic device and sending the information to said touchscreen for display thereon,
a wireless communication unit coupled electrically to said antenna module and said application processor and including a mobile digital transceiver module, said wireless communication unit operating between a digital transmission mode and a mobile telephone mode, said mobile digital transceiver module being controlled when said wireless communication unit is in the digital transmission mode to be connected to the Internet through said antenna module to retrieve data for display on said portable electronic device through said application processor, and said mobile digital transceiver module being controlled when said wireless communication unit is in the mobile telephone mode to generate a dialing interface for display on said portable electronic device through said application processor to allow for input of a telephone number and connection to a telecommunications network using the telephone number, and
a satellite navigation unit coupled electrically to said antenna module and said application processor, and installed with a global satellite positioning system and an electronic map database, said satellite navigation unit performing navigation based on positioning information provided by said global positioning system and an electronic map in said electronic map database, and displaying navigation information on said display of said portable electronic device through said application processor;
wherein said application processor further includes a signal determining module which selects to activate one of said wireless communication unit, said satellite navigation unit, and said auxiliary display module according to a touch-control signal received from said touchscreen.

13. The electronic system of claim 12, wherein said portable electronic device further includes a first connection interface coupled electrically to said host and said mobile communication device further includes a second connection interface coupled electrically to said application processor, said application processor being coupled electrically with said host of said portable electronic device through said second connection interface and said first connection interface.

14. The electronic system of claim 13, wherein said mobile communication device further includes a battery unit for supplying electric power, a power source switching unit coupled electrically to said battery unit and said second connection interface, and a power source management unit coupled electrically to said power source switching unit and said application processor and controlled by said application processor;
said application processor controlling said power source switching unit through said power source management unit to select use of power from said portable electronic device when said application processor is coupled electrically to said portable electronic device;
said application processor controlling said power source switching unit through said power source management unit to select use of power from said battery unit when said application processor is not coupled electrically to said portable electronic device.

15. The electronic system of claim 12, wherein said mobile communication device further includes a Bluetooth® module coupled electrically to said application processor, said application processor automatically activating said Bluetooth® module to transmit and receive conversation signals when said wireless communication unit is in the mobile telephone mode.

16. The electronic system of claim 12, wherein said mobile communication device further includes a memory coupled electrically to said application processor, the information accessed from said portable electronic device by said auxiliary display module and said electronic map database being stored in said memory.
